(19) United States
(12) Patent Application Publication
(10) Pub. No.: US 2020/0147886 A1
(43) Pub. Date: May 14, 2020

(54) VACUUM-ASSISTED INCIDENTAL BUILD MATERIAL COLLECTION WITH RECEPTACLE IN THREE-DIMENSIONAL PRINTER

(71) Applicant: Hewlett-Packard Development Company, L.P., Spring, TX (US)

(72) Inventors: Nicholas WANG, Vancouver, WA (US); Michael CROCKETT, Vancouver, WA (US); William WINTERS, Vancouver, WA (US); Arthur H. BARNES, Vancouver, WA (US); Wesley R. SCHALK, Vancouver, WA (US); Justin M. ROMAN, Vancouver, WA (US)

(73) Assignee: Hewlett-Packard Development Company, L.P., Spring, TX (US)

(21) Appl. No.: 16/620,362

(22) PCT Filed: Jul. 31, 2017
(86) PCT No.: PCT/US2017/044739

§ 371 Date: Dec. 6, 2019

(51) Int. Cl. B29C 64/35; B29C 64/218; B29C 64/357; B29C 64/393; B33Y 30/00; B33Y 50/02; B33Y 40/00; B29C 64/321

(52) U.S. Cl. CPC B29C 64/35; B29C 64/218; B29C 64/357; B29C 64/393; B29C 64/153; B33Y 50/02; B33Y 40/00; B29C 64/321; B33Y 30/00

(57) ABSTRACT

The technology described herein includes a spreader that creates scattered incidental particles in a build chamber when spreading build material is applied in the build platform. One or more vacuum sources create negative pressure zones in one or more receptacles to collect the incidental particles in the build chamber during printing process and thus minimize the scattering of the incidental particles.

### BACKGROUND

A three-dimensional (3D) printing may be formed from an additive printing process used to make three-dimensional solid parts from a digital model. The 3D printing may be used in rapid product prototyping, short-run production, mold generation, and mold master generation.

3D printing uses build material that includes build material that can include plastic, ceramic, metal and other types of material. Build material can include powder that is applied during a printing process. During the printing process incidental particles may be expended. The incidental powder may affect the printing process, parts and components of the printer.

### BRIEF DESCRIPTION OF THE DRAWINGS

FIG. 1 is an example block diagram of a 3D printer in accordance with technology described herein.

FIG. 2 illustrates an example build platform structure in accordance with technology described herein.

FIG. 3A illustrates example timing-activations of dynamically controlled negative pressure zones in accordance with technology described herein.

FIG. 3B illustrates other example timing-activations of dynamically controlled negative pressure zones in accordance with technology described herein.

FIG. 3C illustrates another example timing-activations of dynamically controlled negative pressure zones in accordance with technology described herein.

FIG. 3D illustrates another example timing-activations of dynamically controlled negative pressure zones in accordance with technology described herein.

FIG. 4 is an example process chart illustrating an example method for collecting incidental particles in a printer during a printing process in accordance with technology described herein.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

Described herein is at least a build platform structure to collect incidental particles from a build material, where the build material can include different kinds of plastics, metals, ceramics, etc. Particles can range from about 5 to 50 microns. Build material can include powder. The build platform may be on a build enclosure and particularly, around a build platform structure. For example, a powder dispersal mechanism may perform a powder deposition to form a powder-layer on a build platform of the build platform structure. In this example, and as a consequence, a powder agitation region in which build material may become airborne may be formed above a surface of the build platform. Accordingly, one or more vacuum sources that create negative pressure zones in one or more receptacles may be provided to absorb and minimize the scattering of the incidental particles during the printing process.

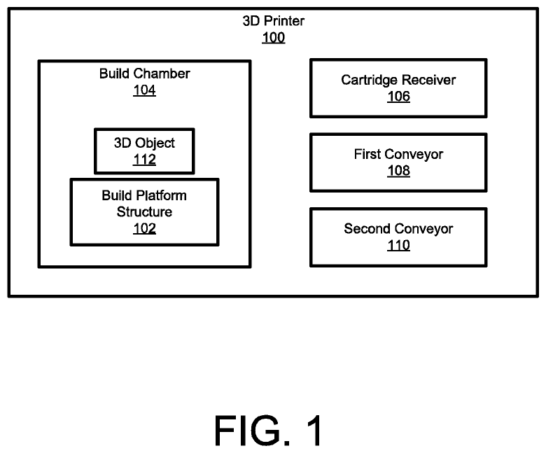

FIG. 1 is an example basic block diagram of a 3D printer in accordance with technology described herein. As shown, a 3D printer 100 may include: a build platform structure 102 that may be disposed within a build enclosure 104; a cartridge receiver 106; a first conveyor 108 that may transport materials from the cartridge receiver 106 to the build platform structure 102; and a second conveyor 110 that may apply a vacuum to the build enclosure 104 in order to absorb or recover incidental or unused build material from the build enclosure 104. A 3D object is printed on the build platform structure 102

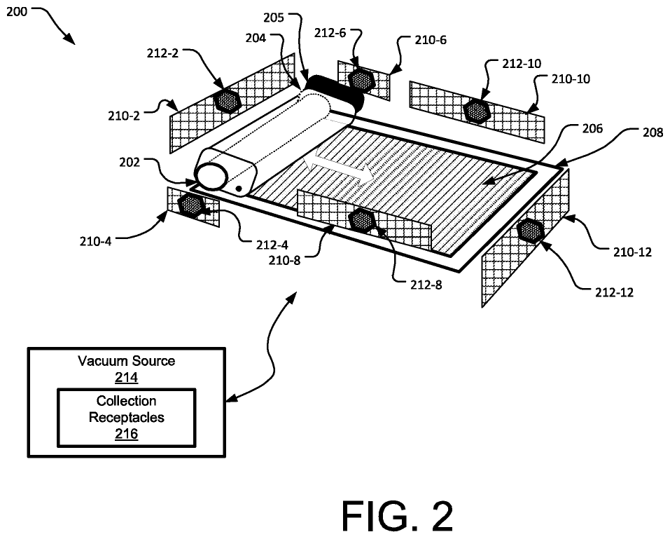

The build platform structure 102, also known as the z-axis movable platform, may provide a system for 3D printing of an object or objects to be built. The build platform structure 102 forms a build chamber 105. 3D objects can be generated in the build chamber 105. The build platform structure 102 may include components such as a powder-dispersing mechanism, a spreader, a build platform, negative pressure zones, and a trigger mechanism as further discussed in FIG. 2 below. These components may be mounted, either directly or indirectly, to an axis transport mechanism, which may be attached to a frame of the 3D printer. The axis transport mechanism, for example, may provide a means for the powder-dispersing mechanism or the spreader to traverse or maneuver above the build platform.

To print a particular object, the 3D printing may include processes such as, but are not limited to: slicing a digital 3D model of the object into two-dimensional slices; selecting a first physical layer; forming a powder-layer; applying a build material on the formed powder-layer to form the first layer; and fusing, for example, through a radiation source of the bound materials.

The cartridge receiver 106 may be disposed adjacent to the build enclosure 104 and may further include a canister that receives incidental build material from the build enclosure 104. The received incidental build materials may be stored for future use or discarded.

For example, the first conveyor 108 may transport the incidental build materials from the cartridge receiver 106 to the powder-dispersing mechanism on the build platform structure 102. In this example, the second conveyor 110 may facilitate recovery of incidental build materials or powder from the build platform structure 102. The second conveyor 110, for example, may include a vacuum system with conduits or a manifold to receive any incidental build material or powder.

Although the example basic block diagram of the 3D printer 100 illustrates in a limited manner the basic components of the 3D printer, other components such as a powder filter assembly, control interfaces, a waste collector unit, etc. are not described in order to simplify the implementations described herein.

FIG. 2 illustrates an example build platform structure 200 as described in accordance with technology described herein. The example build platform structure 200 may represent the build platform structure 102 in FIG. 1. As shown, the build platform structure 200 may include a spreader roller 202 that may be integrated to a build material dispersal mechanism 204, a ribbon spreader 205, a printable area 206 on a build platform 208, multiple negative pressure zones 210 that may be disposed along a perimeter of the build platform 208, and trigger mechanisms 212. FIG. 2 further shows a separate vacuum source or sources 214 that further includes collection receptacles 216. Connections may be provided from the printer build chamber 105 to the vacuum source(s) 214. The vacuum source 214 may represent the second conveyor 110 in FIG. 1 above. As described herein, each vacuum source 214 may include an individual collection receptacle 216 that may be connected to a corresponding negative pressure zone 210 on the build platform structure 200.

During a build material deposition process, the ribbon spreader 205 lays down a thin, wide pile of build material in front of the spreader roller 202. The build material is heated quickly before spreading as a layer. Heating lamps (not shown) may be integrated into the dispersal mechanism 204 to warm build material and fuse 3D objects. The amount of build material dosed to the spreader roller 202 may be modulated by the ribbon spreader 205 speed, ribbon spreader 205 aperture size or screening off the top of the pile by slightly lifting the spreader roller 202. The build material dispersal mechanism 204 may deposit a layer of build material on the printable area 206 of the build platform 208. Furthermore, ribbon spreader 205 may dose build material to build material dispersal mechanism 204 after depositing each layer on build platform 208.

In forming the build material-layer, the build material dispersal mechanism 204 may perform a controlled build material delivery rate on the build platform 208.

During the process of dosing build material to the build material dispersal mechanism 204 with build material, build material that is present in the agitation region may be observed to occur within a perimeter of or to an area close to the build material dispersal mechanism 204. That is, incidental build material materials may scatter in the air proximate to the build material dispersal mechanism 204. Similarly, during the deposition of the one or more build material-layers on the build platform 208, the build material dispersal mechanism 204 traverses the build platform 208 and further creates build material agitation regions along other areas of the build platform 208. During the occurrence of the build material agitation regions in these other areas, the incidental particles in the previous agitation region during the initial build material filling or refilling may significantly decrease in amount as a consequence.

After the formation of the build material-layer on the printable area 206, the spreader 202 may spread a pile of build material or powder on the build platform 208. For example, the spreader 202 is shaped as a roller that may apply a uniform pressure at a certain height on a surface of the build platform 208. In this example, the roller may be coupled to the axis transport mechanism that facilitates the movement of the roller during the spreading process. The movement of the roller towards the edge of the build platform 208, for example, may generate inertial momentum that flings incidental particles off the build platform 208. As a result, the incidental build material may form on the build material agitation regions on the area above a surface of the build platform 208.

In another example, the spreader 202 may be a flat bar that may even out the build material-layer similar to the roller-spreader. In this other example, the flat bar may be coupled to the axis transport mechanism that facilitates the flat bar to move in a linear direction towards an edge of the build platform 208. The movement of the flat bar towards the edge may generate the inertial momentum that flings the incidental particles to the air or may pile up the build material-accumulation on the edge of the build platform 208.

When local occurrences of the build material agitation regions above, the negative pressure zones 210 may be disposed at different locations within the build enclosure 104 and particularly, at locations adjacent to the perimeter of the build platform 208. For example, the negative pressure zone 210-2 may be disposed adjacent to one edge of the build platform 208; negative pressure zones 210-4 and 210-6 may be disposed as an extended flange or channel of the negative pressure zone 210-2 and enveloping corner-edges of the build platform 208; negative pressure zones 210-8 and 210-10 may be disposed as a collinear extension of the negative pressure zones 210-4 and 210-6, respectively, along a main body-length of the build platform 208; and the negative pressure zone 210-12 may be disposed adjacent to another edge of the build platform 208. Although the negative pressure zones 210 are shown to be disposed adjacent to the perimeter of the build platform 208, the negative pressure zones 210 may be disposed on top of the build platform 208, or in other sections of the printer where the build material agitation region may be expected to occur.

Each negative pressure zone 210, for example, may be connected to a corresponding collection receptacle 216, which includes an airflow that may be dynamically controlled by the vacuum source 214. In this example, the airflow may be controlled based on at least: a present action in the print or object recovery process that is being performed; a temperature within the build enclosure 102 or the build platform structure 200; pressure feedback within a printer chamber; pressure feedback from a particular vacuum source 214; compensation for an inoperative vacuum source 214, and particle count measurement in the build enclosure 102 or printer chamber. Particle count measurement can make use of a sensor or instrument to measure particles in the environment, such as build chamber 102.

Although the dynamic control or modulation of the airflow on each negative pressure zone 210 may be set during a calibration of the printer i.e., build material agitation regions may be pre-defined, the trigger mechanisms 212 may detect a triggering condition such as the presence of the build material agitation region in a particular area on the build platform 208. For example, each negative pressure zone 210 may include a corresponding trigger mechanism 212 that may detect the triggering conditions such as presence and/or amount level of the build material agitation region. In this example, the trigger mechanism 212-2, 212-4, . . . and 212-12 may be disposed along the mouth of the negative pressure zones 210-2, 210-4, . . . and 210-12, respectively.

In response to the detected triggering condition by a particular triggering mechanism 212, the dynamic control of the airflow on each negative pressure zone 210 may be implemented on-the-fly. For example, the vacuum source 214 may modulate or regulate the airflow on each negative pressure zone 210 based on a detected triggering condition or a received signal from the corresponding trigger mechanism 212. In this example, one or more negative pressure zones 210 may be operating at the same time but with different air flow modulations.

Detected triggering conditions and vacuum sources may be further modulated based on, but are not limited to the following conditions: detection of the temperature within the build enclosure 104 or the build platform structure 200, the detection of the pressure feedback within the printer chamber or from a particular vacuum source 214, and/or the detection of defective or inoperative vacuum source 214. For example, the trigger mechanisms 212-2 and 212-12 detect different pressure feedbacks for the negative pressure zones 210-2 and 210-12, respectively. In this example, the airflows in the negative pressure zones 210-2 and 210-12 may be adjusted accordingly in order to draw incidental build material from the build material agitated regions and without affecting quality or operations of the printer. Furthermore, detected triggering conditions for which vacuum sources may be modulated, may further include temperature/humidity in the print chamber, temperature/humidity outside of the printer, or a combination thereof; a flow sensor or a limit sensor, such as sensing a downstream sieve is full; post-printing operations such as cooling of the print chamber to make the print chamber accessible for a user after a build object recovery process is complete.

Furthermore, the triggering conditions may be based upon present actions in the printing process or on object recovery processes. Examples of printing actions can include dosing build material or powder to the spreader roller 205 or spreading of builder material or powder on the layer. Other actions can include auto build material or powder extraction from the build enclosure 104 to recover the 3D object. Such actions may be collectively called the “print/object recover processes.” For example, during the build material-refilling of the build material dispersal mechanism 204, the triggering mechanisms 212-2, 212-4, and 212-6 may be utilized as primary sensors to detect presence of the build material agitation regions. In this example, the triggering mechanisms 212-8, 212-10, and 212-12 may be used as secondary sensors to facilitate dynamic control of airflows by the vacuum source 214. In the case of build material deposition process to form the build material-layer or in the spreading process to flatten the formed build material-layer, different triggering mechanisms 212 may be utilized to provide dynamic control of airflows by the vacuum source 214.

As defined herein, the trigger mechanism 212 may compare the detected triggering condition to a pre-defined threshold. For example, in detecting presence of the build material agitation region during build material-refilling of the build material dispersal mechanism 204, the trigger mechanism 212-6 may compare a detected amount of incidental build material material on the build material estimated region to the pre-defined threshold. In response to the comparison, the amount of air flow on the corresponding negative pressure zone 210-6 may be adjusted accordingly.

The negative pressure zones 210 may made of a flexible and thermally stable material such as a silicon material. Furthermore, each of the negative pressure zones 210 may include a rectangular mouth or air inlet that is disposed along perimeter sides of the build platform 208. The rectangular mouth of each of the negative pressure zone 210 may facilitate the drawing of the incidental particles to the corresponding collection receptacle 216. In this example, rectangular mouth dimensions of each negative pressure zones 210 may be adjusted corresponding, for example, to a size of a particular build material agitation region to be detected.

In another example, each negative pressure zones 210 may include different rectangular mouth-shapes and sizes. The rectangular mouth-shape and size may be based upon the area of the build material agitation regions and/or the amount of airflow for a particular negative pressure zone 210.

The vacuum source 214 may control the airflows or creates a continuous negative pressure on each of the negative pressure zones 210 by adjusting, for example, a blower that provides the negative pressure inside the corresponding collection receptacle 216. In this example, the control of the airflows may be set, or adjusted on the fly based upon control signals or detected triggering conditions received from the trigger mechanisms 212.

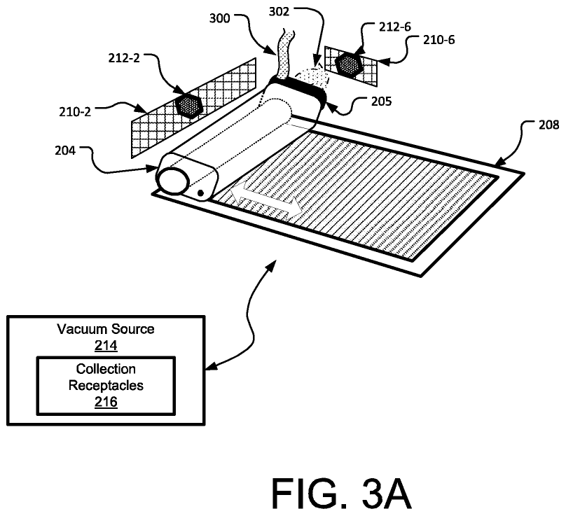

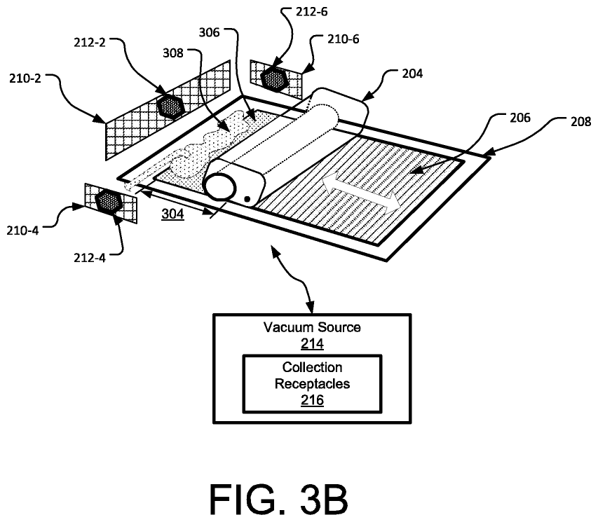

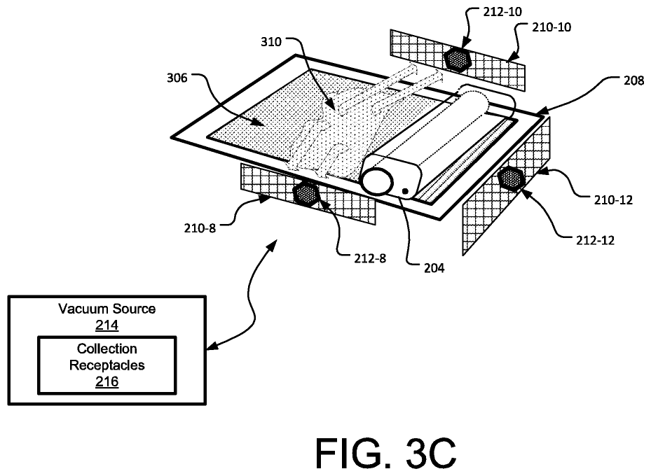

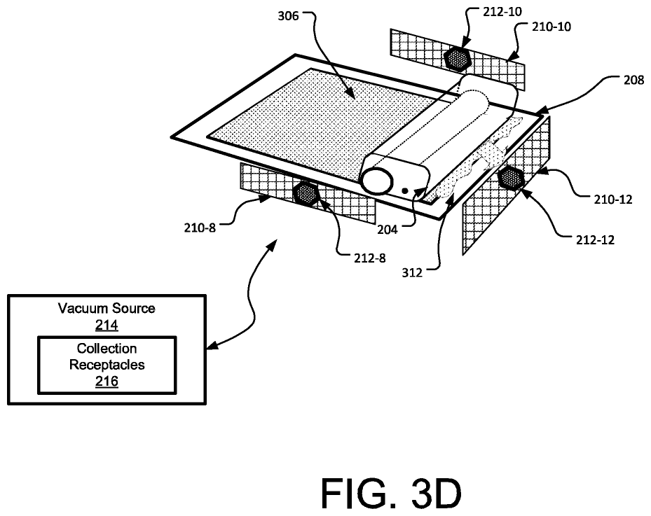

FIG. 3A shows an initial stage of a build material deposition process where the ribbon spreader 205 may be filled with build material through a powder-inlet 300. For example, the powder dispensing mechanism 204 may be initially positioned on one edge of the build platform 208 and closer to the locations of the negative pressure zones 210-2 and 210-6. In this configuration, and during the powder-filling of the powder dispensing mechanism 204, a powder agitation region 302 may be estimated to be present near the negative pressure zone 210-6. Consequently, the negative pressure zone 210-6 may activate during the build material-filling to absorb incidental build material that may have been scattered on the air and particularly, the scattered build material from the build material agitation region 302.

Alternatively, the trigger mechanism 212-6 may be utilized to detect the triggering condition such as detecting presence and amount of air scattered-build material on the build material agitation 302. In response to the detected triggering condition, the negative pressure zone 210-6 may be activated during the build material-filling to absorb the air scattered-build material from the build material agitation region 302.

Similarly, the trigger mechanism 212-2 corresponding to the negative pressure zone 210-2 may detect triggering conditions such as a temperature within the build enclosure 104. In a case where the detected temperature may implement a different airflow modulation, the negative pressure zone 210-2 may have a different amount of negative pressure as compared to the negative pressure zone 210-6. Furthermore, the negative pressure zones 210-2 and 210-6 may be dynamically controlled based on subsequent triggering condition detections by the trigger mechanisms 212-2 and 212-6, respectively.

FIG. 3B shows the build material dispensing mechanism 204 to be traversing the build platform 208 to a certain distance such as, for example, a distance 304. That is, the build material dispensing mechanism 204 traverses the build platform 208 during the build material deposition process to form a build material-layer 306. The distance 304, for example, may include a length that is more or less equal to rectangular mouth-length of the negative pressure zone 210-4. In this example, a build material agitation region 308 may be estimated to occur within an area defined at least by a length of the distance 304. Although shown build material agitation region 308 is shown as occurring behind the build material dispensing mechanism 204 (which includes spreader roller 202), it is to be understood that build material agitation region 308 may also be in front of dispensing mechanism 204 (spreader roller 202). Consequently, the negative pressure zone 210-4 may activate when the build material dispersal mechanism 204 has more or less travelled the distance 304 from one edge of the build platform 208.

Alternatively, the trigger mechanism 212-4 may be utilized to detect the triggering condition such as presence and amount of air scattered-build material within the build material agitation region 308. In response to the detected triggering condition, the negative pressure zone 210-4 may be activated to absorb the air scattered-build material from the build material agitation region 308. Furthermore, the trigger mechanisms 212-2 and 212-6 may detect triggering conditions such as the pressure feedback within the printer chamber or from a particular vacuum source 214. In response to the detected triggering conditions, the negative pressure zones 210-2 and 210-6 may be activated to have different amount of negative pressures based on airflow of the detected triggering conditions. That is, the negative pressure zones 210-2 and 210-6, for example, may merely provide temperature or pressure reduction of different negative pressures from that of the activated negative pressure zone 210-4.

FIG. 3C shows an example build material deposition process where the build material dispensing mechanism 204 is about to reach the edge of the build platform 208. As shown, a build material agitation region 310 may be estimated to occur along center of the build platform 208 or within an area in between the negative pressure zones 210-8 and 210-10. In this case, the negative pressure zones 210-8 and 210-10 may activate when the build material dispensing mechanism 204 is about to reach the other edge of the build platform 208 during the build material deposition process. The activated negative pressure zones 210-8 and 210-10 may absorb the air scattered-build material from the build material agitation region 310.

Alternatively, the trigger mechanisms 212-8 and 212-10 may be utilized to detect the triggering condition such as the amount of the air scattered-build material on the powder agitation region 310 that is located along an area on the middle of the build platform 208. In response to the detected triggering condition, the negative pressure zones 210-8 and 210-10 may be activated to absorb the air scattered-powder from the powder agitation region 310.

Furthermore, the trigger mechanism 212-12 may detect triggering conditions related to the activation of the negative pressure zone 210-12. In response to the detected triggering conditions by the trigger mechanism 212-12, the negative pressure zone 210-12 may be activated to have a different amount of negative pressure based on airflow of the detected triggering conditions.

FIG. 3D shows an example build material deposition process where the build material dispensing mechanism 204 is about to perform a bilateral spread at the opposite direction. As shown, a build material agitation region 312 may be estimated to occur at the edge of the build platform 208. In this case, the negative pressure zone 210-12 may activate when the build material dispensing mechanism 204 is about to perform a bilateral spread at the opposite direction along the other edge of the build platform 208. Alternatively, the trigger mechanism 212-12 may be utilized to detect the triggering condition such as an amount of the air scattered-build material within the build material agitation region 312 along the edge of the build platform 208.

In response to the detected triggering condition, the negative pressure zone 210-12 may be activated to absorb the air scattered-build material from the build material agitation region 312.

Furthermore, the trigger mechanisms 212-8 and 212-10 may detect triggering conditions such as an inoperative vacuum source for the negative pressure zone 210-12. To compensate for the detected inoperative vacuum source, the negative pressure zones 210-8 and 210-10 may be activated with different amounts of negative pressures to compensate for the detected inoperative vacuum source. In such a case, the negative pressure zones 210-8 and 210-10 may have different airflow modulations as compared to the airflow on the negative pressure zone 210-12.

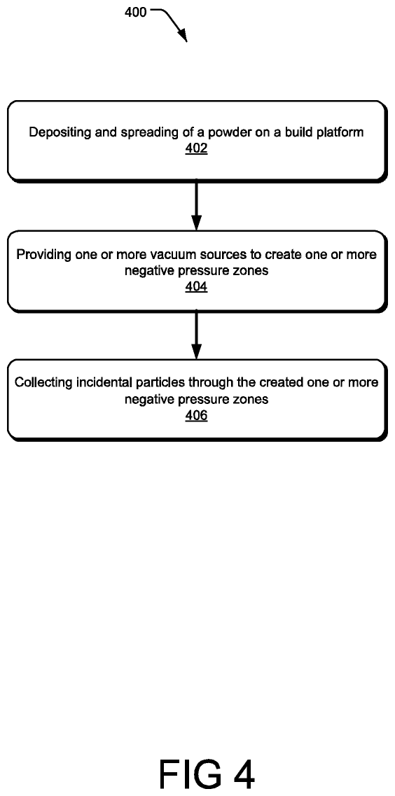

FIG. 4 shows an example process chart 400 illustrating an example method for collecting incidental particles in a printer during a printing process. The order in which the method is described is not intended to be construed as a limitation, and any number of the described method blocks can be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof.

At block 402, spreading a build material having particles, in a build chamber of the printer during a printing process is performed. For example, the build material dispersal mechanism 204 performs a build material deposition to form the build material-layer 306 on the build platform 208. In this example, build material agitation regions such as the build material agitation regions 308 and 310 may be generated. In another example, the spreading of the formed build material-layer 306 may similarly generate build material agitation regions. In this other example, the spreading generates inertial momentum that scatters incidental build material particles in the air.

At block 404, providing one or more vacuum sources of the printer that create negative pressure zones in one or more receptacles to minimize the scattering of the incidental particles during the printing process is performed. For example, the negative pressure zones 210-8 and 210-10 may be disposed adjacent to each length of the build platform 208. In this example, the corresponding vacuum sources 214 that are respectively connected to the negative pressure zones 210-8 and 210-10 may create negative pressures in order to absorb incidental or incidental particles from the build material agitation region 310. As described herein, the build material agitation region 310 may be estimated during the calibration of the printer, or the presence and amount level of the build material agitation region 310 may be detected through the trigger mechanism 212.

At block 406, collecting the incidental particles in the one or more receptacles is performed. For example, the negative pressure zones 210-8 and 210-10 may absorb incidental or incidental particles from the powder agitation region 310. In another example, the negative pressure zone 210-4 may absorb incidental or incidental particles from the powder agitation region 308. In these examples, the collected incidental particles may be reused in the printing process.

Alternatively, the trigger mechanisms 212 corresponding to the negative pressure zones 210-4, 210-8 and 210-10 may be utilized to detect triggering conditions such as the presence and amount of the powder agitation regions 308 and 310. In this case, the negative pressure zones 210-4, 210-8 and 210-10 may be activated to have a certain amount of negative pressures depending upon airflow of the detected triggering conditions. For example, to compensate for the inoperative negative pressure zone 210-4, the negative pressures on the negative pressure zones 210-8 and 210-10 may be adjusted accordingly.

Furthermore, the detection of the triggering conditions above may include comparison of the detected triggering condition to a pre-defined threshold. The pre-defined threshold, for example, may include an estimated amount of air scattered -powder on the powder agitation region, the allowable feedback pressure, normal temperature within the printer chamber, and the like.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

These processes are illustrated as a collection of blocks in a logical flow graph, which represents a sequence of operations that can be implemented in mechanics alone, with hardware, and/or with hardware in combination with firmware or software. In the context of software/firmware, the blocks represent instructions stored on one or more computer-readable storage media that, when executed by one or more processors, perform the recited operations.

Note that the order in which the processes are described is not intended to be construed as a limitation, and any number of the described process blocks can be combined in any order to implement the processes or an alternate process. Additionally, individual blocks may be deleted from the processes without departing from the spirit and scope of the subject matter described herein.

The term “computer-readable media” is non-transitory computer-storage media or non-transitory computer-readable storage media. For example, computer-storage media or computer-readable storage media may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick—and SD cards), and volatile and non-volatile memory (e.g., random access memory (RAM), read-only memory (ROM)).

What is claimed is:

1. A three-dimensional printer comprising:
a spreader to spread a build material on a build platform;
connections to one or more vacuum sources that create multiple negative pressure zones proximately located to the build platform, that during a printing process facilitate to collect and reduce scatter of incidental particles from the build material, wherein the vacuum sources are regulated by one or more conditions in a printing process.

2. The three-dimensional printer of claim 1, wherein the build platform is integrated in the three-dimensional (3D) printer.

3. The three-dimensional printer of claim 1, wherein the incidental particles are reused in the printing process.

4. The three-dimensional printer of claim 1 further comprising one or more collection receptacles, wherein the negative pressure zones are created in the one or more collection receptacles.

5. The three-dimensional printer of claim 1, wherein the negative pressure zones created by the one or more vacuum sources are modulated based on one of or more of the following:
actions in the printing process or an object recovery process;
temperature within a build chamber;
pressure feedback within the build chamber;
pressure feedback from a particular vacuum source;
compensation for an inoperative vacuum source;
temperature or humidity in the build chamber;
temperature or humidity outside of the three-dimensional printer;
a flow sensor or a limit sensor; and
post-printing operations.

6. The printer build chamber of claim 1, wherein the multiple vacuum sources provide a continuous negative pressure zone within one or more collection receptacles.

7. A three-dimensional printer comprising:
a build material spreader to distribute a build material into a build enclosure during a printing process;
one or more vacuum sources, the one or more vacuum sources being activated by one or more conditions in the printing process to create multiple negative pressure zones distributed on a build platform of the build enclosure, during the printing process that collect and reduce scatter of incidental particles of the powder; and
one or more collection receptacles to receive incidental particles from the build enclosure.

8. The three-dimensional printer of claim 7, further comprising one or more air inlets to operate with the one or more vacuum sources to create the multiple negative pressure zones.

9. The three-dimensional printer of claim 7, wherein the one or more negative pressure zones created by the one or more vacuum sources are modulated based on one of or more of the following:
actions in the printing process or an object recovery process;
temperature within a build chamber;
pressure feedback within the build chamber;
pressure feedback from a particular vacuum source;
compensation for an inoperative vacuum source;
temperature or humidity in the build chamber;
temperature or humidity outside of the three-dimensional printer;
a flow sensor or a limit sensor; and
post-printing operations.

10. The three-dimensional printer of claim 7, wherein the one or more vacuum sources are to provide continuous negative pressure zones.

11. A method to collect incidental particles in a printer comprising:
spreading a particulate build material on a build platform;
regulating one or more vacuum sources of the printer that are activated upon one or more conditions in a printing process to create negative pressure zones in one or more receptacles to minimize the scattering of the incidental particles during the printing process; and
collecting the incidental particles in the one or more receptacles.

12. The method of claim 11, wherein the spreading of the powder includes one or more air inlets in operation with the one or more vacuum sources to create the negative pressure zones.

13. The method of claim 11, wherein the providing of the one or more vacuum sources is based on one or more of the following:
actions in the printing process or an object recovery process;
temperature within a build chamber;
pressure feedback within the build chamber;
pressure feedback from a particular vacuum source;
compensation for an inoperative vacuum source;
temperature or humidity in the build chamber;
temperature or humidity outside of the printer;
a flow sensor or a limit sensor; and
post-printing operations.

14. The method of claim 11, wherein the providing of the one or more vacuum sources creates continuous negative pressure zones.

15. The method of claim 11 further comprising reusing the incidental particles that are collected in the one or more receptacles in the printing process.
